(19) United States
(12) Patent Application Publication
(10) Pub. No.: US 2025/0017215 A1
(43) Pub. Date: Jan. 16, 2025

(54) LIQUID CARRIER CONCENTRATE COMPRISING AT LEAST ONE BENEFICIAL MICROORGANISM AND USES THEREOF

(71) Applicant: SPECIALTY OPERATIONS FRANCE, Lyon (FR)

(72) Inventors: Monique Adamy, Asnières-Sur-Seine (FR); Fernanda De Oliveira Barreto Costa, Paulínia (BR); Elisa Coelho, Paulínia (BR)

(73) Assignee: SPECIALTY OPERATIONS FRANCE, Lyon (FR)

(21) Appl. No.: 18/712,230

(22) PCT Filed: Nov. 24, 2022
(86) PCT No.: PCT/EP2022/083208

§ 371 Date: May 21, 2024

(30) Foreign Application Priority Data
Nov. 24, 2021 (EP) 21210154.7

(51) Int. Cl. A01N 63/23; A01N 25/02; A01N 63/30; A01P 21/00

(52) U.S. Cl. CPC A01N 63/23; A01N 25/02; A01N 63/30; A01P 21/00

(57) ABSTRACT

The present invention relates to a liquid carrier concentrate comprising at least one beneficial microorganism selected from the group consisting of Bacillus, Streptomyces, Beauveria, Trichoderma, Metarhizium, Paecilomyces, Isaria, Baculovirus, Azospirillum, Penicillium and Rhizobium and at least one specific solvent. The present invention also relates to an agricultural active formulation obtainable by diluting or dispersing said liquid carrier concentrate. The invention also concerns a method for treating soils, plants and/or seeds to control pests and/or to regulate the growth of plants and/or to induce the defense response in plants and/or to enhance metabolic and physiological processes within plants and soils, by applying the liquid carrier concentrate or the agricultural active formulation.

The present invention relates to a liquid carrier concentrate comprising at least one beneficial microorganism selected from the group consisting of Bacillus, Streptomyces, Beauveria, Trichoderma, Metarhizium, Paecilomyces, Isaria, Baculovirus, Azospirillum, Penicillium and Rhizobium and at least one specific solvent. The present invention also relates to an agricultural active formulation comprising said liquid carrier concentrate or obtainable by diluting said liquid carrier concentrate. The invention also concerns a method for treating soils, plants and/or seeds to control pests and/or to regulate the growth of plants and/or to induce the defense response in plants and/or to enhance metabolic and physiological processes within plants and soil by using said agricultural active formulation or liquid carrier concentrate.

### BACKGROUND OF THE INVENTION

In recent years, both environmental and human health concerns have fostered interest in promoting alternatives to synthetic pesticides.

Through the use of living microorganisms, natural substances or semiochemicals, biological control agents prevent or reduce damage from pests and pathogens, emerging as one of the most promising tools for sustainable agriculture.

However, the global rate of adoption of biological control-based solutions remains relatively low in comparison with conventional pesticides, with often less consistent biological efficacy reported in the field, in adverse conditions.

The main concern is the ability to provide an efficient concentrate composition formulated to keep the microorganisms stable, limit or prevent premature growth and/or germination before application, while maintaining their viability in the formulated composition over periods of storage. The formulated composition should in addition be readily available for dilution or addition to various applications.

Another well-known problem is that bacterial or fungal microbial spores have a strong tendency to agglomerate as such in concentrate formulations, or upon dilution in water. This causes significant application issues for the end user such as the risk of nozzles clogging on delivery devices, and/or the adhesion to the inner surface of a delivery tank (often referred to as “staining”), hence the lack of biological availability of microbial active and its metabolites to the targeted surface, with potential biological efficacy issues. There is a need for microbial formulations with enhanced dispersion characteristics, especially upon dilution in water prior to application.

Previous formulated compositions are notably disclosed in US 2011/0033436 which is directed to aqueous formulations of various spore forming bacteria and fungi. However, aqueous based formulations are problematic due to the nature of water and the need for harsh preservatives to prevent pathogens growth. Such preservatives can be harmful to the viability of beneficial microorganisms, impacting drastically their germination rate, once reactivated. Furthermore some types of microorganisms such as fungal spores need to be formulated in a medium free of water (or comprising a low concentration of water) to keep them in a dormant state, with inactivated metabolism, in order to achieve a reasonable shelf life, longer storage stability. Further, aqueous based formulations are not compatible with other non-aqueous agricultural products, which presents difficulty in applying the pesticide.

US 2017/0347665 discloses non-aqueous, non-oil microbial compositions and their use for the preparation of pesticides. These compositions contain a liquid carrier which is preferably selected from polyethylene glycol, glycerol, ethylene glycol, dipropylene glycol, propylene carbonate or mixture thereof. However, some of these organic solvents may in some circumstances be phytotoxic to the spores.

Thus there is a need for the provision of formulations containing at least one beneficial microorganism and a solvent having advantageously improved properties:
towards the beneficial microorganisms, notably:
   improved viability of the microorganism during storage,
   improved physical stability, with no or little sedimentation
in the applications, in particular compatible with other agricultural products, and with improved dispersion characteristics upon dilution in water,
safe towards the environment and human health.

### BRIEF DESCRIPTION OF THE INVENTION

It has been found, unexpectedly, that a liquid carrier concentrate, comprising at least one beneficial microorganism selected from the group consisting of Bacillus, Streptomyces, Beauveria, Trichoderma, Metarhizium, Paecilomyces, Isaria, Baculovirus, Azospirillum, Penicillium and Rhizobium and at least one specific dioxolane-based solvent, advantageously provides superior stability, viability and growth of the beneficial microorganisms. The liquid carrier concentrates of the present invention can also be qualified as greener, or more environmentally friendly compared to traditional synthetic pesticide formulations.

The present invention further relates to an agricultural active formulation obtainable by diluting or dispersing the liquid carrier concentrate of the invention, preferably in water, generally with a dilution rate which ranges from 0.1% to 10% by volume.

The present invention also provides a method for treating soils, plants and/or seeds to control pests and/or to regulate the growth of plants and/or to induce the defense response in plants and/or to enhance metabolic and physiological processes within plants and soil by using said agricultural active formulation or liquid carrier concentrate, preferably comprising applying an effective amount of said agricultural active formulation or liquid carrier concentrate to plants (crop or undesired ones), seeds or to the soil.

### DETAILED DESCRIPTION OF THE INVENTION

The present invention relates to a liquid carrier concentrate, comprising at least one beneficial microorganism selected from the group consisting of Bacillus, Streptomyces, Beauveria, Trichoderma, Metarhizium, Paecilomyces, Isaria, Baculovirus, Azospirillum, Penicillium and Rhizobium, and at least one (dioxolane-based) solvent, this solvent being a compound of formula (I):

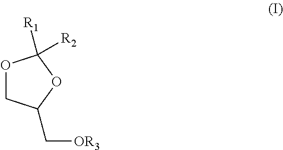

wherein R₁ and R₂, independent from one another, are selected in the group consisting of: a linear or branched C₁-C₁₂ alkyl, a C₄-C₁₂ cycloalkyl or an aryl, R₃ is H, a linear or branched alkyl, a cycloalkyl, or a —C(═O)R₄ group, with R₄ being a linear or branched C₁-C₄ alkyl or C₅-C₆ cycloalkyl.

The liquid carrier concentrate of the present invention may display one or more advantages, notably:
The liquid carrier concentrate may have an increased shelf-life in comparison to one or more controls, in particular the beneficial microorganisms may have an increased viability after storage for a defined period of time at a defined temperature, as compared to one or more controls,
The liquid carrier concentrate may be free of water, and therefore limits the need for preservatives, in particular no preservative or less preservative is needed,
The liquid carrier concentrate may have an improved physical stability and/or homogeneity, in particular no or little phase separation or sedimentation or aggregation may be observed, thus improving the handling of the liquid carrier concentrate, in comparison to one or more controls,
In comparison with one more controls, the liquid carrier concentrate may have enhanced dispersion characteristics and an improved homogeneity upon application, in particular the agglomeration issues known upon dilution are reduced, improving the handling of the agricultural active formulation obtainable by dilution of the liquid carrier concentrate,
The liquid carrier concentrate may have an improved compatibility when combined with fertilizers for in-furrow applications, or during planting or when combined with other agrochemical products in the spray tank mixture, in comparison with one or more controls,
The liquid carrier concentrate may boost or increase the germination rate of microorganisms and/or enhance the metabolites production of the microorganisms, upon application of the liquid carrier concentrate or of the agricultural active formulation obtainable by dilution of the liquid carrier concentrate in water, in comparison with one or more controls,
The liquid carrier concentrate may provide an increased or at least improved biological efficacy of microorganisms and/or their metabolites upon application, in particular when coated on the seed, or applied on the soil, either through application of the liquid carrier concentrate or a dispersion or dilution thereof in water, in comparison with one or more controls,
Seeds coated or soils treated with an effective amount of the liquid carrier concentrate and/or an effective amount of the agricultural active formulation of the invention may provide an enhanced plant growth, in comparison with seed coated or soils treated with an effective amount of one or more controls,
The number of root nodules of leguminous plants derived from seeds treated with an effective amount of the liquid carrier concentrate and/or an effective amount of the agricultural active formulation of the invention, may be higher, in comparison with the one of leguminous plants derived from seeds treated with one or more controls,
The liquid concentrate may provide an increased viability and/or survival rate of the microorganisms during or after application, in particular after coating on the seed, or application on the soil, of the liquid concentrate or a dispersion or dilution thereof in water, in comparison with one or more controls,
The liquid carrier concentrate may provide an increased germination rate of the microorganisms upon application, in particular after coating on the seed, or application on the soil of the liquid carrier concentrate or a dispersion or dilution thereof in water, in comparison with one or more controls.

As used herein, the term “control” refers to dried state of spores, or water-based concentrate of spores, or to other liquid carriers or solvents of comparison containing spores.

As used herein, the term “increased shelf-life” refers to the fact that the liquid carrier concentrate is able to increase the viability of the beneficial microorganism after a certain period of storage at a specific temperature, as compared to one or more controls.

As used herein, the term “increased germination rate” refers to the fact that a greater fraction of the dormant spores are able to germinate after dispersion of the liquid carrier concentrate in a water-based liquid as compared to one or more controls.

As used herein, the term “boost” refers to the fact that an improvement of the germination of dormant spores after dispersion of the liquid carrier concentrate in a water-based liquid as compared to one or more controls.

As used herein, the term “enhanced dispersion” refers to an improvement in one or more characteristics of microbial dispersion, as compared to one or more controls. Exemplary microbial dispersion characteristics include, but are not limited to, the percentage of microbes that exist as single cells/spores when the composition is diluted in water.

As used herein, the term “enhanced plant growth” refers to an improvement in one or more characteristics of plant growth and/or development as compared to one or more control plants. Exemplary plant growth/development characteristics include, but are not limited to, biomass, chlorophyll content, cold tolerance, drought tolerance, height, leaf length, leaf mass, leaf number, leaf surface area, root area, root diameter, root length, root mass, root nodulation (e.g., nodule mass, nodule number, nodule volume), root number, root surface area, root volume, salt tolerance, seed germination, seedling emergence, stomatal conductance and survival rate.

### Beneficial Microorganism

As used herein, the term “beneficial microorganism” means any microorganism, whether in a vegetative state, a dormant state (e.g., spore) or a whole broth culture, any substance derived from a microorganism (including proteins or secondary metabolites), or any fermentation product (e.g., supernatants, filtrates, extracts, etc.) that are beneficial to a plant.

According to the invention, the term “beneficial microorganisms” is intended to include (i) biopesticides, (ii) microorganisms that improve plant nutrition and (iii) microorganisms that induce the defense response in plants, or that are capable of enhancing metabolic & physiological processes within plants and soils.

In one embodiment, the beneficial microorganism may especially be a biopesticide.

As used herein, the term “pesticidal” means any agent or combination of agents that is pathogenic to at least one target pest (e.g., a nematode, an insect, an acari, a fungal pest, a bacterial pest, a viral pest), especially on a plant and/or a seed.

As used herein, the term “biopesticide” (which is equivalent to “microbial pesticide”), means any microorganism, whether in a vegetative state, a dormant state (e.g., spore) or a whole broth culture, any substance derived from a microorganism (e.g. proteins or metabolites), or any fermentation product (e.g., supernatants, filtrates, extracts, etc.) that are pathogenic to a pest (e.g., capable of attacking, infecting, killing, disabling, causing disease, compete with and/or causing injury to a pest), in particular on a plant and/or a seed, and is thus able to be used in the control of a pest by adversely affecting the viability or growth of the target pest. Non-limiting examples of “microbial pesticides” include microbial nematicides, microbial insecticides, microbial fungicides, microbial bactericides, and microbial virucides.

As used herein, “derived from” means directly isolated or obtained from a particular source or alternatively having identifying characteristics of a substance or organism isolated or obtained from a particular source. In the event that the “source” is an organism, “derived from” means that it may be isolated or obtained from the organism itself or medium used to culture or grow said organism.

As used herein, “whole broth culture” refers to a liquid culture containing both cells and media. If bacteria are grown on a plate the cells can be harvested in water or other liquid, whole culture. As used herein, the term “supernatant” refers to the liquid remaining when cells grown in broth or are harvested in another liquid from an agar plate and are removed by centrifugation, filtration, sedimentation, or other means well known in the art.

As defined herein, “filtrate” refers to liquid from a whole broth culture that has passed through a membrane.

As defined herein, “extract” refers to liquid substance removed from cells by a solvent (water, detergent, buffer) and separated from the cells by centrifugation, filtration or other method.

As used herein, “metabolite” refers to a compound, substance or byproduct of a fermentation of a microorganism, or supernatant, filtrate, or extract obtained from a beneficial microorganism, for instance from a microorganism that has pesticidal and particularly, insecticidal activity.

As used herein, the terms “spore”, “microbial spore”, etc., has its normal meaning which is well known and understood by those of skill in the art (i.e., a microorganism in its dormant, protected state).

As used herein, the term “herbicide(s)” is intended to refer to any agent or combination of agents capable of killing weeds and/or inhibiting the growth of weeds (the inhibition being reversible under certain conditions), in particular on a plant and/or a seed.

As used herein, the term “fungicide(s)” is intended to refer to any agent or combination of agents capable of killing fungi and/or inhibiting fungal growth, in particular on a plant and/or a seed.

As used herein, the term “nematicide” or “nematicidal” is intended to refer to any agent or combination of agents capable of killing one or more nematodes and/or inhibiting the growth of one or more nematodes, in particular on a plant and/or a seed.

As used herein, the term “insecticide” or “insecticidal” is intended to refer to any agent or combination of agents capable of killing one or more insects and/or inhibiting the growth of one or more insects, in particular on a plant and/or a seed. As used herein, the term “acaricide” or “acaricidal” is intended to refer to any agent or combination of agents capable of killing one or more acarids and/or inhibiting the growth of one or more acarids, in particular on a plant and/or a seed.

An “agricultural active” formulation is intended to denote formulations which, either use in its concentrated form or in dilution in water to a targeted use rate, causes or provides a beneficial and/or a useful effect in agriculture and/or provides a biological activity in a soil or, above all, in a seed or a plant, for example to control pests and/or to regulate the growth of plants and/or to induce the defense response in plants and/or to enhance metabolic and physiological processes within soils or, above all, within plants.

According to the present invention, the beneficial microorganism is selected from the group consisting of Bacillus, Streptomyces, Beauveria, Trichoderma, Metarhizium, Paecilomyces, Isaria, Baculovirus, Azospirillum, Penicillium and Rhizobium, preferably from the group consisting of Bacillus, Beauveria, Trichoderma, Metarhizium, Paecilomyces, Isaria, Baculovirus, Azospirillum, Penicillium and Rhizobium, more preferably from the group consisting of Bacillus, Beauveria, Trichoderma, Paecilomyces and Rhizobium, in particular from the group consisting of Bacillus, Beauveria, Paecilomyces and Trichoderma.

According to an embodiment of the present invention, the beneficial microorganism is selected from the group consisting of Bacillus, Streptomyces, Beauveria, Penicillium, Metarhizium, Paecilomyces, Isaria, Baculovirus, Azospirillum and Rhizobium, in particular from the group consisting of Bacillus, Beauveria, Penicillium, Metarhizium, Paecilomyces, Isaria, Baculovirus and Azospirillum.

According to the present invention, the beneficial microorganism can possibly be selected from the group consisting of Streptomyces, Beauveria, Metarhizium, Penicillium, Paecilomyces, Isaria, Baculovirus and Azospirillum, for example from the group consisting of Beauveria, Metarhizium, Penicillium, Paecilomyces, Isaria, Baculovirus and Azospirillum.

According to a particular embodiment of the invention, the beneficial microorganism is preferably selected from the group consisting of Bacillus, Beauveria and Paecilomyces, for instance from Beauveria and Paecilomyces.

According to the invention and to any one of the invention embodiments or variants, the beneficial microorganism of the invention may be a biopesticide chosen from fungal spores or bacterial spores.

Examples of fungal spores or conidia that are insecticidal or nematicidal or fungicidal include but not limited to the following genii: Beauveria, Trichoderma, Metarhizium, Paecilomyces, and Isaria, specifically the following fungi: Beauveria bassiana, Trichoderma harzianum or Paecilomyces lilacinus.

Examples of bacterial spores include Bacillus, including but not limited to Bacillus agri, Bacillus aizawai, Bacillus albolactis, Bacillus amyloliquefaciens, Bacillus cereus, Bacillus circulans, Bacillus coagulans, Bacillus endoparasiticus, Bacillus endorhythmos, Bacillus firmus, Bacillus kurstaki, Bacillus lacticola, Bacillus lactimorbus, Bacillus lactis, Bacillus laterosporus, Bacillus lentimorbus, Bacillus licheniformis, Bacillus macerans, Bacillus megaterium, Bacillus medusa, Bacillus metiens, Bacillus natto, Bacillus nigricans, Bacillus popillae, Bacillus pumiliss, Bacillus pumilus, Bacillus siamensis, Bacillus sphaehcus, Bacillus spp., Bacillus subtilis, Bacillus thuringiensis, Bacillus unflagellatus, plus those listed in the category of Bacillus Genus in the “Todar's Online Textbook of Bacteriology, (2009)”. Also included, even though the presence of Streptomyces in the liquid carrier concentrate according to the invention is not a preferred embodiment of the invention, are Streptomyces galbus, Streptomyces griseoviridis, Streptomyces candidus, Streptomyces lydicus, Streptomyces saraceticus, Streptomyces venezuelae, Streptomyces acidiscabies, Streptomyces goshikiensis, Streptomyces lavendulae, Streptomyces prasinus, Streptomyces prasinus, Streptomyces rimosus. Also included are Photorhabdus luminescens, Xenorhabdus nematophilus, Pantoea agglomerans, and those nematicidal bacterial antagonists listed in “Nematology Advances and Perspectives, Vol. 2 (2004)”.

In a preferable embodiment, the bacterial spores are Bacillus subtilis, Bacillus amyloliquefaciens, or more preferably Bacillus thuringiensis.

Example of Penicillium spores include Penicillium bilaiae, Penicillium brevicompactum, Penicillium canescens, Penicillium expansum, Penicillium expansum, Penicillium fellatanum, Penicillium gaestrivorus, Penicillium glabrum, Penicillium janthinellum, Penicillium lanosocoeruleum, Penicillium radicum, Penicillium raistrickii.

In one embodiment of the present invention, beneficial microorganism agents are selected among root colonizing bacteria, nitrogen-fixing bacteria and/or inoculants, for example Rhizobium leguminosarum, Rhizobium tropici, Rhizobium loti, Rhizobium trifolii, Rhizobium meliloti, Rhizobium fredii, or preferably: Azorhizobium caulinodans, Pseudomonas, Azospirillum, Azotobacter, Bradyrhizobium.

Beneficial microorganism agents such as fungi or bacteria may be obtained by conventional fermentation processes. The fermentation can be carried out using solid, semi-solid or liquid nutrient media. If spores such as conidia are used, preference is given to solid or semi-solid nutrient media. The nutrient media contain the nutrients suitable and known for the cultivation of the respective microorganisms, in particular one or more metabolizable carbon sources or nitrogen sources and mineral salts. The fermentation is generally carried out at temperatures between about 3° C. and about 40° C., preferably between 20° C. and 35° C. For example, a representative fermentation is described in U.S. Pat. No. 5,804,208.

A fermentation process comprises in general the steps of a) incubating spores such as conidia of a microorganism in or on a nutrition medium (such as agar with further additives such as oatmeal); b) separating spores such as conidia from the nutrition medium after the incubation time, (e.g., by shake off the conidia from the medium, centrifuging, filtrating); and optionally c) preparing an emulsion of said isolated conidia. The person skilled in the art is well aware how to adapt fermentation to a given microorganism such as fungi or bacteria.

### Solvent

The at least one solvent comprised in the liquid carrier concentrate according to the invention, which is a dioxolane-based solvent, is a compound of formula (I):

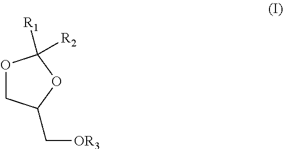

wherein R₁ and R₂, independent from one another, are selected in the group consisting of: a linear or branched C₁-C₁₂ alkyl, a C₄-C₁₂ cycloalkyl or an aryl, R₃ is H, a linear or branched alkyl, a cycloalkyl, or a —C(═O)R₄ group, with R₄ being a linear or branched C₁-C₄ alkyl or C₅-C₆ cycloalkyl.

In a preferred embodiment, R₁ and R₂, independently from one another, are selected in the group consisting of: methyl, ethyl, isopropyl, n-propyl, isobutyl, n-butyl, tert-butyl, n-pentyl, cyclopentyl, cyclohexyl or phenyl.

Advantageously, in formula (I) above, R₃ is H or a —C(═O)R₄ group, with R₄ being methyl, ethyl, isopropyl, n-propyl, isobutyl, n-butyl or tert-butyl. More preferably, R₃ is H.

One very preferred embodiment is when R₁ and R₂ are methyl and R₃ is H. A corresponding commercial compound is for example Rhodiasolv® Li-Tec 2V, Augeo SL191 or Solketal. This compound can be synthesized by reaction between glycerol and acetone, under well-known classical conditions. Glycerol can be for instance obtained as a coproduct from biodiesel production during the transesterification of triglycerides.

One embodiment is to have R₁ and R₂ are methyl and R₃ is a —C(═O)R₄ group, with R₄ being methyl. A corresponding commercial compound can be synthesized by transesterification of Solketal with an alkyl acetate, under well-known classical conditions.

In a less preferred embodiment, R₁ is methyl, R₂ isobutyl and R₃ is H. It can be synthesized by reaction between glycerol and methyl-isobutyl ketone, under well-known classical conditions.

In another less preferred embodiment, R₁ is methyl, R₂ is phenyl and R₃ is H. A corresponding commercial compound can be synthesized by reaction between glycerol and acetophenone, under well-known classical conditions.

According to a specific embodiment, the compound of formula (I) is a bio-based compound.

According to a specific embodiment, the at least one solvent contained in the liquid carrier concentrate of the invention comprises a compound of formula (I) and a compound of the following formula (II), wherein R₁, R₂ and R₃ have the same meaning as for formula (I):

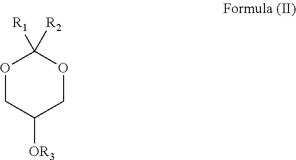

Advantageously the at least one compound of formula (I) contained in the solvent-based liquid carrier concentrate according to the invention is inert towards the microorganism(s), in particular the compound of formula (I) has little or even no phytotoxic effect towards the microorganism(s).

### Liquid Carrier Concentrate

According to the present invention, the liquid carrier concentrate comprises:
at least one beneficial microorganism as defined above, and
at least one dioxolane-based solvent as defined above.

According to an embodiment, the liquid carrier concentrate of the invention comprises:
at least one beneficial microorganism selected from the group consisting of Bacillus, Beauveria, Trichoderma, Metarhizium, Paecilomyces, Isaria, Baculovirus, Azospirillum, Penicillium and Rhizobium, more preferably selected from Bacillus, Beauveria, Paecilomyces and Trichoderma, in particular selected from Bacillus, Beauveria, Paecilomyces, for example chosen among Beauveria and Paecilomyces, and
at least one solvent, this solvent being a compound of formula (I):

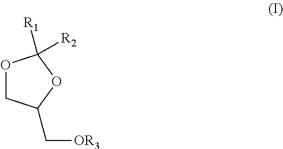

wherein R₁ and R₂ are methyl, and R₃ is H.

According to another embodiment, the liquid carrier concentrate of the invention comprises:
at least one beneficial microorganism selected from the group consisting of Bacillus, Beauveria, Trichoderma, Metarhizium, Paecilomyces, Isaria, Baculovirus, Azospirillum, Penicillium and Rhizobium, more preferably selected from Bacillus, Beauveria, Paecilomyces and Trichoderma, in particular selected from Bacillus, Beauveria, Paecilomyces, for example chosen among Beauveria and Paecilomyces, and
at least one solvent, this solvent being a compound of formula (I):

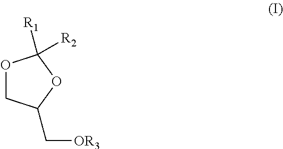

wherein R₁ and R₂ are methyl and R₃ is a —C(═O)R₄ group, with R₄ being methyl.

According to a particular embodiment of the present invention, the liquid carrier concentrate comprises:
at least one beneficial microorganism as defined above,
at least one dioxolane-based solvent as defined above, and
at least one rheology modifier.

The rheology modifier may bring suspension properties or anti-settling properties and/or may allow to adjust the viscosity at a suitable range for the application.

The rheology modifier which may be used in this particular embodiment of the present invention is preferably derived from minerals. The rheology modifier may possibly provide good stability. The rheology modifier can be for example selected from the group consisting of silica particles, gelling clays including in particular bentonite, hectorite, laponite, attapulgite, sepiolite, smectite, or hydrophobically/organophilic modified bentonite.

Suitable amounts of rheology modifiers in the liquid carrier concentrate according to the invention are for instance used in the range of 0.1 to 12% by weight, in particular of 0.1 to 10% by weight, and for example of 0.5 to 7% by weight.

In order to disperse silicas or clays in a given fluid, high shear mixing can be desirable to form a gel, as it is known in the art.

Global producers for silicas are for example Solvay, Evonik, Cabot Corporation, Wacker Chemie, Dow Corning, OCI and PPG Industries.

Other possible examples of rheology modifiers are clay thickeners. Clay thickeners are generally micronized layered silicates that can be effective thickeners for a wide range of applications. They are typically employed either in their non-hydrophobized or hydrophobized form. In order to make them dispersible in non-aqueous solvents, the clay surface can usually be treated with quaternary ammonium salts. These modified clays are known as organo-modified clay thickeners. Optionally, small amounts of alcohols of low molecular weight or water may be employed as activators. Examples for such clay-based rheology modifiers include for example smectite, bentonite, hectorite, attapulgite, laponite, sepiolite or montmorillonite clays. Other possible examples of rheology modifiers are organic rheological modifiers based on modified hydrogenated castor oil (trihydroxystearin) or castor oil organic derivatives.

A rheology modifier as hydrophobic fumed silica, in particular fumed silica surface-treated with polydimethylsiloxane, such as Aerosil® R 202, can be preferably used.

According to a particular embodiment, the liquid carrier concentrate according to the invention has a viscosity, measured at 20 rpm using a Brookfield RV viscometer at 25° C. and at atmospheric pressure (1.013×10⁵ Pa), which ranges from 500 mPa·s to 5000 mPa·s; more preferentially from 700 to 3000 mPa·s; even more preferentially from 700 to 2500 mPa·s.

The liquid carrier concentrate according to the invention may further contain additive(s) different from the beneficial microorganism, the specific dioxolane-based solvent and the optional rheology modifier, as described previously. These further additives are preferably selected from the group consisting of surfactants (e.g. anionic, amphoteric, or non-ionic), binders, diluents, solvents, absorbents, stabilizers, dispersants, wetting agents, emulsifying agents, retention and rainfastness agents, antifoam agents, antifreeze agents, antioxidants, dyes and pigments, water-repellents, UV-stabilizers, adjuvants, viscosity modifiers, penetrants, sequestering agents and/or preservatives.

The liquid carrier concentrate of the invention may thus comprise at least one surfactant, in particular at least one non-ionic surfactant.

Each additive can be present in the liquid carrier concentrate according to the invention in an amount ranging from 0% to 20% by weight, in particular from 0% to 10% by weight, relative to the total weight of the liquid carrier concentrate. Each additive can be for instance present in the liquid carrier concentrate according to the invention in an amount ranging from 0.1% to 20% by weight, in particular from 0.1% to 10% by weight, relative to the total weight of the liquid carrier concentrate. Each additive can be present in the liquid carrier concentrate according to the invention in an amount preferably ranging from 0% to 5% by weight, notably from 0.1% to 5% by weight, relative to the total weight of the liquid carrier concentrate.

The person skilled in the art will be able to choose these optional additives and their amounts so that they do not harm the properties of the liquid carrier concentrate of the present invention.

The liquid carrier concentrate may be preferentially in the form of a dispersion, a suspension of the beneficial microorganisms in the dioxolane-based solvent alone or possibly in the presence of water, a co-solvent such as glycols like glycerol or polyethyleneglycol.

The liquid carrier concentrate of the invention can be in the form of a concentrated aqueous emulsion (EW), wherein the specific dioxolane-based solvent and the beneficial microorganism form an emulsion in water.

The liquid carrier concentrate of the present invention comprises at least one beneficial microorganism.

Generally, the amount of beneficial microorganism in the liquid carrier concentrate according to the invention ranges from 1 to 95% by weight, in particular from 3 to 70% by weight, for instance from 3 to 60% by weight, and even more preferentially from 5 to 40% by weight, relative to the total weight of the liquid carrier concentrate.

The amount of beneficial microorganism in the liquid carrier concentrate may usually range from 1.5×10⁴ CFU/g to 1×10¹¹ CFU/g, preferentially from 1×10⁶ CFU/g to 5×10¹⁰ CFU/g.

The liquid carrier concentrate of the present invention generally comprises at least 5 wt %, more particularly from 5 to 99 wt %, for instance from 5 to 97% wt %, notably from 5 to 95 wt % of solvent as defined above (formula (I) and its different embodiments), based on the total weight of the solvent-based liquid concentrate (i.e. of the liquid carrier concentrate).

The liquid carrier concentrate of the present invention comprises preferably at least 40 wt %, more preferably at least 60 wt %, or even at least 80 wt %, of solvent as defined above (formula (I) and its different embodiments), based on the total weight of the liquid carrier concentrate. It can comprise from 40 to 99 wt %, in particular from 40 to 97% wt %, for example from 40 to 95 wt %, notably from 40 to 90 wt % of solvent as defined above (formula (I) and its different embodiments), based on the total weight of the liquid carrier concentrate.

It can also comprise from 60 to 99 wt %, in particular from 60 to 97% wt %, for example from 60 to 95 wt %, notably from 60 to 90 wt %, or even from 60 to 80 wt %, of solvent as defined above (formula (I) and its different embodiments), based on the total weight of the liquid carrier concentrate.

In some variants, the liquid carrier concentrate of the present invention comprises from 80 to 99 wt %, in particular from 85 to 97% wt %, for example from 90 to 97 wt %, of solvent as defined above (formula (I) and its different embodiments), based on the total weight of the liquid carrier concentrate.

Known conventional methods for preparing agricultural products may be implemented. It is possible to undertake this by simply mixing the constituents.

### The Additional Agricultural Materials

The liquid carrier concentrate according to the invention may further comprise at least one additional agricultural material chosen from pesticides different from the beneficial microorganism agents as described above, nutrients, biostimulants, plant growth regulators, and mixtures thereof.

According to the invention, the additional agricultural material(s) which may be used in the liquid carrier concentrate are different from the beneficial microorganism used in the liquid carrier concentrate of the invention.

The liquid carrier concentrate according to the invention may comprise at least one pesticide different from the beneficial microorganism used in such liquid carrier concentrate.

For example, these pesticides may be chosen from fungicides, herbicides, insecticides, algicides, molluscicides, miticides, nematicides, and rodenticides.

The person skilled in the art is familiar with such pesticides, which can be found, for example, in the Pesticide Manual, 16th Ed. (2013), The British Crop Protection Council, London.

If the liquid carrier concentrate according to the invention comprises one or more additional pesticides different from the beneficial microorganism as described above, it is understood that those skilled in the art will choose the pesticide(s) which will not adversely affect the effectiveness of the beneficial microorganism.

The liquid carrier concentrate according to the invention may comprise at least one nutrient. “Nutrients” refer to chemical elements and compounds which are desired or necessary to promote or improve plant growth. Nutrients generally are described as macronutrients or micronutrients.

Suitable nutrients for use in the liquid carrier concentrate according to the invention may be micronutrient compounds, preferably those which are solid at room temperature (about 25° C.) or are partially soluble.

Micronutrients typically refer to trace metals or trace elements, and are often applied in lower doses. Suitable micronutrients include trace elements selected from zinc, boron, chlorine, copper, iron, molybdenum, and manganese.

The micronutrients may be in a soluble form or included as insoluble solids, and may be in the form of salts or chelates. Preferably, the micronutrient is in the form of a carbonate or oxide.

Preferably, the micronutrients may be selected from zinc, calcium, molybdenum or manganese, or magnesium. More preferentially, micronutrients for use in the liquid carrier concentrate according to the invention may be selected from zinc oxide, manganese carbonate, manganese oxide, or calcium carbonate.

The liquid carrier concentrate according to the present invention may also comprise at least one macronutrient.

Macronutrients typically refer to those comprising nitrogen, phosphorus, and potassium, and typically include fertilizers such as ammonium sulphate, and water conditioning agents.

Suitable macronutrients include fertilisers and other nitrogen, phosphorus, or sulphur containing compounds, and water conditioning agents.

Suitable fertilisers include inorganic fertilisers that provide nutrients such as nitrogen, phosphorus, potassium or sulphur. Examples of such fertilisers include:
for nitrogen as the nutrient: nitrates and or ammonium salts such as ammonium nitrate, including in combination with urea e.g. as uran type materials, calcium ammonium nitrate, ammonium sulphate nitrate, ammonium phosphates, particularly mono-ammonium phosphate, di-ammonium phosphate and ammonium polyphosphate, ammonium sulphate, and the less commonly used calcium nitrate, sodium nitrate, potassium nitrate and ammonium chloride;
for phosphorus as the nutrient: acidic forms of phosphorus such as phosphoric, pyrophosphoric or polyphosphoric acids, but more usually salt forms such as ammonium phosphates, particularly mono-ammonium phosphate, di-ammonium phosphate, and ammonium polyphosphate, potassium phosphates, particularly potassium dihydrogen phosphate and potassium polyphosphate;
for sulphur as the nutrient: ammonium sulphate and potassium sulphate, e.g. the mixed sulphate with magnesium.

The liquid carrier concentrate according to the invention may comprise at least one biostimulant.

The term “biostimulant” is intended to mean a compound which may enhance metabolic or physiological processes such as respiration, photosynthesis, nucleic acid uptake, ion uptake, nutrient delivery, or a combination thereof.

Non-limiting examples of biostimulants include seaweed extracts (e.g., ascophyllum nodosum), humic acids (e.g., potassium humate), fulvic acids, myoinositol, glycine, and combinations thereof.

The liquid carrier concentrate according to the invention may comprise at least one plant growth regulator.

Plant growth regulators mean active ingredients used to influence the growth characteristics of plants. Examples of plant growth regulators which may be used in the present disclosure include, but are not limited to: 1-naphthaleneacetic acid, 1-naphthaleneacetic acid-salt, 1-napthol, 2,4-dichlorophenoxyacetic acid (2,4-D), 2,4-DB, 2,4-DEP, 2,3,5-triiodobenzoic acid, 2,4,5-trichlorophenoxyacetic acid, 2-naphthoxyacetic acid, 2-naphthoxyacetic acid sodium salt, 3-chloro-4-hydroxyphenylacetic acid, 3-indoleacetic acid, 4-biphenylacetic acid, 4-chlorophenoxyacetic acid (4-CPA), 4-hydroxyphenylacetic acid, 6-benzylaminopurine, auxindole, a-naphthaleneacetic acid K-salt, β-naphfhoxyacetic acid, p-chlorophenoxyacetic acid, dicamba, dichlorprop, fenoprop, indole-3-acetic acid (IAA), indole-3-acetyl-DL-aspartic acid, indole-3-acetyl-DL-tryptophan, indole-3-acetyl-L-alanine, indole-3-acetyl-L-valine, indole-3-butyric acid (IBA), indole-3-butyric acid K-salt, indole-3-propionic acid; a-naphthaleneacetic acid, methyl indole-3-acetate, naphthaleneacetamide, naphthaleneacetic acid (NAA), phenylacetic acid, picloram, potassium naphthenate, sodium naphthenate, 4-hydroxyphenethyl alcohol, 4-CPPU, 6-benzylaminopurine (BA), 6-(Y, Y-dimethylallylamino)purine (2iP), 2-iP-2HCl, adenine, adenine hemisulfate, benzyladenine, kinetin, meta-topolin, N6-benzoyladenine, N-benzyl-9-(2-tetrahydropyranyl) adenine (BP A), N-(2-chloro-4-pyridyl)-N-phenylurea, gibberellic acid (GA3), gibberellins, gibberellins A4+A7 (GA n), ethylene and abscisic acid.

Preferably, when the liquid carrier concentrate according to the invention further comprises at least one additional agricultural material, the amount of additional agricultural material(s) in the liquid carrier concentrate ranges from 0.01 to 60% by weight, more preferentially from 0.05 to 30% by weight; even more preferentially from 0.1 to 20% by weight; and even from 1 to 10% by weight, relative to the total weight of the liquid carrier concentrate.

The total content of additional agricultural material(s) in the liquid carrier concentrate may range from 1 to 60% by weight, more preferentially from 2 to 30% by weight, and even more preferentially from 5 to 20% by weight, relative to the total weight of the liquid carrier concentrate according to the invention.

### Agricultural Targets

According to the invention the term “agricultural target” is intended to cover plant parts and soil.

In one exemplary, and preferred, embodiment, the agricultural target is a plant part.

As used herein, the term “plant part” is to be understood as meaning all parts and organs of plants above and below the ground, such as shoot, leaf, flower and root, examples which may be mentioned being leaves, needles, stalks, stems, flowers, fruit bodies, fruits, seeds, roots, tubers and rhizomes. The plant parts also include harvested material and vegetative and generative propagation material (e.g., cuttings, tubers, rhizomes, off-shoots and seeds, etc.).

In one particular, and preferred, embodiment, the agricultural target is plant seed.

In another embodiment, the agricultural target is plant foliage.

As used herein, the term “foliage” is intended to mean all parts and organs of plants above the ground. Non-limiting examples include leaves, needles, stalks, stems, flowers, fruit bodies, fruits, etc. As used herein, the term “foliar application”, “foliarly applied”, and variations thereof, is intended to include application of a formulation to the foliage or above ground portions of the plant, (e.g., the leaves of the plant).

In another embodiment, the agricultural target is soil.

Agricultural growth medium, or other agricultural substrates, are also considered as possible agricultural targets in the sense of the present invention.

The term “agricultural target” does not cover microbial culture media used in microbiology.

In any case, according to the invention, the agricultural target of the invention is thus different from a culture media used in microbiology.

According to any one of the invention embodiments, the agricultural target may cover various crops and plants.

The agricultural target and the use in agriculture according to the invention do not comprise/cover the animal health and in particular the use against parasites in or on animals.

The advantageous agricultural target or use in agriculture according to the present invention is the applications regarding plants or seeds.

### Agricultural Active Formulation

The present invention is also relative to an agricultural active formulation comprising the liquid carrier concentrate in accordance with the invention as defined above.

According to an embodiment, the present invention relates to an agricultural active formulation obtainable, or which is obtained, by diluting or dispersing the liquid carrier concentrate of the invention.

According to this embodiment, the agricultural active formulation is generally a dilution or dispersion of the liquid carrier concentrate with a dilution ratio which may vary significantly depending notably on the crop and the target, for example from grams to kgs of the formulation per hectare.

According to this embodiment, the liquid carrier concentrate may be diluted (or dispersed) in water.

In an embodiment, the agriculture active formulation in accordance with the invention is not in an encapsulated form. In other words, in this embodiment, the agriculture active formulation of the invention is not encapsulated in a material. And even without such encapsulation, the viability of the beneficial microorganisms is advantageously ensured.

Method for Treating Soils, Plants and/or Seeds

The present invention also provides a method for treating soils, plants and/or seeds, preferably to control pests and/or to regulate the growth of plants and/or to induce the defense response in plants and/or to enhance metabolic and physiological processes within plants and soils, by applying the liquid carrier concentrate of the present invention or the agricultural active formulation of the present invention to at least one plant, area adjacent to a plant, soil adapted to support growth of a plant, root of a plant, foliage of a plant, and/or seed adapted to produce a plant.

The method may be performed at any stage of development of the plant. The liquid carrier concentrate or the agricultural active formulation of the present invention may be applied on the whole plant or on parts thereof.

More particularly, the method according to the invention is for treating plants and/or seeds, preferably to control pests and/or to regulate the growth of plants and/or to induce the defense response in plants and/or to enhance metabolic and physiological processes within plants, by applying the liquid carrier concentrate of the present invention or the agricultural active formulation of the present invention to at least one plant, area adjacent to a plant, root of a plant, foliage of a plant, and/or seed adapted to produce a plant.

Preferably the method comprises the application of an effective amount of the liquid carrier concentrate or of the agricultural active formulation to plants (in particular crop or undesired ones), seeds or to the soil, in particular next to the plant or the seed.

More particularly, the method comprises the application of an effective amount of the liquid carrier concentrate or of the agricultural active formulation to plants (in particular crop or undesired ones) or to seeds, in particular next to the plant or the seed.

As used herein, the expression “effective amount” is defined as the amount of the beneficial microorganism sufficient to provide the beneficial effect to the plant (or to the seed).

For instance, when the beneficial microorganism is a biopesticide, the terms “effective amount” may be defined as the amount of the biopesticide sufficient to cause infection in the pest which will then lead to the controlling of pests. The actual effective amount in absolute value may depend on various factors including, but not limited to, the mortality rate of the pest or pests relative to the rate at which the biopesticide is applied, synergistic or antagonistic interactions between the other active or inert ingredients which may increase or reduce the activity of the biopesticide, the inherent susceptibility of the life stage and species of pest, and the stability of the biopesticide in compositions.

The “effective amount” of the beneficial microorganism, for instance the biopesticide, of the invention may be determined, e.g., by a routine dose response experiment.

Preferably, the method of the present invention is applied to seeds. Such method is preferably carried out by coating the seeds with the agricultural active formulation or the liquid carrier concentrate. Suitable known coating techniques may be utilized to coat the seeds or agglomeration of seed, and any suitable equipment or technique may be employed. Equipment that may be utilized for coating can include but are not limited to drum coaters, rotary coaters, tumbling drums, fluidized beds and spouted beds. The seeds may be coated via a batch or a continuous coating process.

The method of the present invention may be applied to any plant in need of treatment, in particular landscape plants, fruit trees, nut trees, fruit vines, vegetable crops and cereal crops. The method of the present invention may be applied onto the foliar system of the plant. Such application is preferably carried out by spraying an agricultural active formulation or the liquid carrier concentrate of the present invention onto the leaves of the plant. For example, the agricultural active formulation or the liquid carrier concentrate can be sprayed onto a field using appropriate means well known in agriculture.

In a general manner, the invention can be easily carried out using conventional and commercially available application equipment.

The method of the present invention may also be applied to an area where crops are grown.

In a specific embodiment, the method of the present invention may include the application of an herbicide, a fungicide, an insecticide and or a foliar fertilizer.

The liquid carrier concentrate of the invention and the agricultural active formulation of the invention can possibly be in a non-encapsulated form (in other words, not encapsulated in a material). For example, in the methods of the invention, they can possibly be used in a non-encapsulated form.

The agricultural active formulation of the present invention or the liquid carrier concentrate of the present invention may be applied by any convenient means, familiar to those skilled in the art, such as, for instance, spraying, soil application, in-furrow treatment or side-dressing.

The following examples illustrate the invention without limiting however the scope thereof.

### Examples

Standard procedure for microbial viability assessment of liquid carrier concentrates upon accelerated storage stability study (Shelf-life assessment) In order to evaluate the shelf-life of liquid carrier concentrate of the fungi, the liquid carrier concentrates were prepared by mixing 5 wt % of a commercial product (biopesticide) containing a beneficial microorganism and 95 wt % of the solvent to be tested.

The commercial products tested were in powder form, and the beneficial microorganisms in the composition were:
Beauveria bassiana,
Paecilomyces lilacinus.

For comparison, a control experiment without the solvent was prepared. For Beauveria bassiana and Paecilomyces lilacinus, 5 wt % of the powder commercial product was added to 95 wt % soybean oil, 2-ethylhexyl lactate or isoamyl laurate.

The preparations were incubated under accelerated temperature test conditions, at 25° C. and the viability of the microorganism was evaluated after 0, 15 days, 1 month, 3 months, 6 months, 9 months, 12 months and 14 months of incubation without agitation. Trials were performed in duplicates.

Viability evaluation of bacteria was performed similarly to the description above, by adding 5 wt % of a commercial product (biopesticide) containing a beneficial microorganism and 95 wt % of the solvent to be tested. The commercial products tested were also in powder form, and the beneficial microorganisms in the composition was:
Bacillus thuringiensis

For comparison, a control experiment without the solvent was prepared. The same concentration of 5 wt % of the commercial power containing Bacillus thuringiensis was added to 95 wt % water.

Assays were done in triplicates and flasks were stored at 30° C. and under agitation of 150 revolutions per minute (rpm). Viability was analyzed after 0, 1, 7 and 15 days of storage.

### Microorganisms Viability Evaluation

To confirm that the microorganisms were viable after determined incubation/storage time, traditional serial dilution and plating of the samples for colony counting were performed.

For fungi evaluation, samples of 0.1 mL were taken from each preparation and added to 0.9 mL of an aqueous solution containing 0.1% of Tween 80 (polyoxyethylene sorbitan monooleate) to obtain a 10⁻¹ dilution. Then 0.1 mL of this dilution was added to 0.9 mL of the same aqueous solution successively until the most appropriate dilution was obtained (usually between 10-4 and 10-7). 0.2 mL of the most appropriate dilutions were spread into petri dishes containing the proper culture media for each microorganism and incubated (at 25° C. for Beauveria bassiana and Paecilomyces lilacinus), until the colony grew.

In the case of Bacillus thuringiensis evaluation, the dilutions were performed in pure sterile water, and 0.1 mL of the appropriate dilutions were plated using the drop plate method.

The number of the colonies on each petri dish was counted and the results are expressed by colony forming units (CFU)/mL.

### Results

### Microbial Viability Assessment of Liquid Carrier Concentrates Upon Accelerated Storage Stability Study (Shelf-Life Assessment)

Shelf-life assessment was done on two different fungi (Beauveria bassiana and Paecilomyces lilacinus) in Augeo SL191 solvent (formula (I), with R₁, R₂: methyl, and R₃: H) and in three other benchmark solvents or oils according to the experimental procedures described above. For each microorganism, isoamyl laurate was tested in a different run series which explains the difference between its initial microorganism concentration (CFU/mL) and the one of the other three solvents. The recurrent colony counting was done at different incubation times: t=0, 15 days, 1 month, then every month until the CFU/mL value of a sample drops by two log 10 scale (>100 times), i.e. a reduction of 99%.

From the tables below, it can be seen that the viability of both microorganisms in Augeo SL191 stayed above 1E+06 CFU/mL even after 14 months storage at 25° C., compared to the ones of both microorganisms in 2-ethyl hexyl lactate, which decreased very rapidly (less than 1E+05 CFU/mL after 1 month storage) or in soybean oil or in isoamyl laurate (less than 1E+04 CFU/mL after 6 or 9 months storage).

TABLE 1

| | | Comparative | Comparative | Comparative |
|---|---|---|---|---|
| | Example 1 | Example 1a | Example 1b | Example 1c |
| Beneficial | Beauveria bassiana | | | |
| microorganism | | | | |
| Solvent | Augeo SL191 | Soybean oil | 2-ethylhexyl | Isoamyl laurate |
| | | | lactate | |
| Initial | 6.38E+07 | | | 1.16E+07 |
| microorganism | | | | |
| viability | | | | |
| (CFU/mL) | | | | |
| Viability after | 3.50E+07 | 2.31E+07 | 2.50E+05 | not tested |
| 15 days | | | | |
| Viability after 1 | 2.70E+07 | 4.25E+06 | 2.78E+04 | 1.75E+07 |
| month | | | | |
| Viability after 3 | 1.96E+07 | 3.35E+06 | — | 6.54E+06 |
| months | | | | |
| Viability after 6 | 8.38E+06 | 2.00E+06 | — | 4.13E+05 |
| months | | | | |
| Viability after 9 | 1.33E+07 | only | — | — |
| months | | contamination | | |
| | | (~E+02) | | |
| Viability after | 5.25E+06 | — | — | — |
| 12 months | | | | |
| Viability after | 2.65E+06 | — | — | — |
| 14 months | | | | |

TABLE 2

| | | Comparative | Comparative | Comparative |
|---|---|---|---|---|
| | Example 2 | Example 2a | Example 2b | Example 2c |
| Beneficial | Paecilomyces lilacinus | | | |
| microorganism | | | | |
| Solvent | Augeo SL191 | Soybean oil | 2-ethylhexyl | Isoamyl laurate |
| | | | lactate | |
| Initial | 2.36E+07 | | | 1.63E+07 |
| microorganism | | | | |
| viability | | | | |
| (CFU/mL) | | | | |
| Viability after | 2.94E+07 | 2.83E+07 | 4.13E+05 | not tested |
| 15 days | | | | |
| Viability after 1 | 1.68E+07 | 2.18E+06 | 9.38E+04 | 1.10E+07 |
| month | | | | |
| Viability after 3 | 1.38E+07 | 2.25E+06 | — | 1.89E+06 |
| months | | | | |
| Viability after 6 | 8.75E+06 | 2.25E+04 | — | 4.00E+04 |
| months | | | | |
| Viability after 9 | 3.81E+06 | only | — | — |
| months | | contamination | | |
| | | (~E+01) | | |
| Viability after | 1.51E+06 | — | — | — |
| 12 months | | | | |
| Viability after | 1.21E+06 | — | — | — |
| 14 months | | | | |

Microbial Viability Assessment of Liquid Carrier Concentrates with Bacillus thuringiensis Upon Accelerated Storage Stability Study (Shelf-Life Assessment)

Shelf-life assessment was done on Bacillus thuringiensis in Augeo SL191 solvent and a benchmark solvent according to the experimental procedures described above. After 15 days storage at 30° C., a slightly superior viability was obtained with the dioxolane-based solvent as a liquid carrier (example 3) versus water (comparative example 3a).

And, above all, as the liquid carrier concentrate with Augeo SL191 in Example 3 does not contain water, the need for introduction of a preservative to prevent pathogens growth in the concentrate can be avoided. Such preservative can indeed be harmful to the viability of Bacillus spores, impacting drastically their germination rate and it is thus an advantage to avoid the presence of preservatives in a water-free carrier.

TABLE 3

| | Example 3 | Comparative Example 3a |
|---|---|---|
| Beneficial | Bacillus thuringiensis | |
| microorganism | | |
| Solvent | Augeo SL191 | Water |
| Initial microorganism | 3.98E+09 | 2.33E+09 |
| viability (CFU/mL) | | |
| Viability after 1 day | 2.20E+09 | 1.54E+09 |
| Viability after 7 days | 1.21E+09 | 1.12E+09 |
| Viability after 15 days | 1.32E+09 | 1.19E+09 |

1. A liquid carrier concentrate comprising at least one beneficial microorganism selected from the group consisting of Bacillus, Streptomyces, Beauveria, Trichoderma, Metarhizium, Paecilomyces, Isaria, Baculovirus, Azospirillum, Penicillium and Rhizobium and at least one solvent, this solvent being a compound of formula (I): 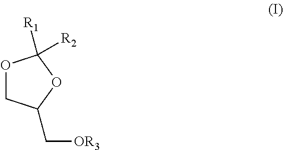
wherein:
R₁ and R₂, independent from one another, are selected in the group consisting of: a linear or branched C₁-C₁₂ alkyl, a C₄-C₁₂ cycloalkyl or an aryl;
R₃ is H, a linear or branched alkyl, a cycloalkyl, or a —C(═O)R₄ group; and
R₄ is a linear or branched C₁-C₄ alkyl or C₅-C₆ cycloalkyl.

2. The liquid carrier concentrate according to claim 1 wherein the at least one beneficial microorganism is selected from the group consisting of Bacillus, Beauveria, Trichoderma, Metarhizium, Paecilomyces, Isaria, Baculovirus, Azospirillum, Penicillium and Rhizobium.

3. The liquid carrier concentrate according to claim 1 wherein the at least one beneficial microorganism is selected from the group consisting of Bacillus, Beauveria, Trichoderma, Paecilomyces and Rhizobium.

4. The liquid carrier concentrate according to claim 1 wherein R₁ and R₂, independently from one another, are selected in the group consisting of: methyl, ethyl, isopropyl, n-propyl, isobutyl, n-butyl, tert-butyl, n-pentyl, cyclopentyl, cyclohexyl or phenyl.

5. The liquid carrier concentrate according to claim 1 R₃ is H or a —C(═O)R₄ group, with R₄ being methyl, ethyl, isopropyl, n-propyl, isobutyl, n-butyl or tert-butyl.

6. The liquid carrier concentrate according to claim 1 wherein R₁ is methyl, R₂ is phenyl and R₃ is H.

7. The liquid carrier concentrate according to claim 1 wherein R₁ and R₂ are methyl and R₃ is H.

8. The liquid carrier concentrate according to claim 1 wherein R₁ and R₂ are methyl and R₃ is a —C(═O)R₄ group, and R₄ is methyl.

9. The liquid carrier concentrate comprising:
at least one beneficial microorganism selected from the group consisting of Bacillus, Beauveria, Trichoderma, Metarhizium, Paecilomyces, Isaria, Baculovirus, Azospirillum, Penicillium and Rhizobium, and
at least one solvent, this solvent being a compound of formula (I): 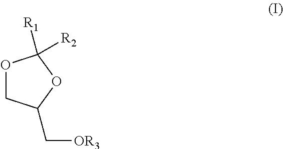
wherein R₁ and R₂ are methyl, and R₃ is H.

10. The liquid carrier concentrate comprising:
at least one beneficial microorganism selected from the group consisting of Bacillus, Beauveria, Trichoderma, Metarhizium, Paecilomyces, Isaria, Baculovirus, Azospirillum, Penicillium and Rhizobium, and
at least one solvent this solvent being a compound of formula (I): 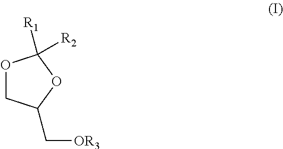
wherein R₁ and R₂ are methyl, R₃ is a —C(═O)R₄ group, and R₄ is methyl.

11. The liquid carrier concentrate according to claim 1 comprising at least 40 wt %, of said solvent, based on the total weight of the liquid carrier concentrate.

12. The liquid carrier concentrate according to claim 1 further comprising at least one rheology modifier.

13. The liquid carrier concentrate according to claim 1 which has a viscosity measured at 20 rpm using a Brookfield RV viscometer at 25° C. and at atmospheric pressure (1.013×10⁵ Pa), which ranges from 500 mPa·s to 5,000 mPa·s.

14. The liquid carrier concentrate according to claim 1 further comprising at least one additional agricultural material chosen from pesticides different from the said beneficial microorganism, nutrients, biostimulants, plant growth regulators, and mixtures thereof.

15. An agricultural active formulation comprising the liquid carrier concentrate as defined in claim 1.

16. The agricultural active formulation obtained by diluting or dispersing the liquid carrier concentrate as defined in claim 1.

17. A method for treating soils, plants and/or seeds to control pests and/or to regulate the growth of plants and/or to induce the defense response in plants and/or to enhance metabolic and physiological processes within plants and soils, by applying the liquid carrier concentrate as defined in claim 1 or an agricultural active formulation comprising the liquid carrier concentrate to at least one plant, area adjacent to a plant, soil adapted to support growth of a plant, root of a plant, foliage of a plant, and/or seed adapted to produce a plant.

18. The method according to claim 17 for treating plants and/or seeds to control pests and/or to regulate the growth of plants and/or to induce the defense response in plants and/or to enhance metabolic and physiological processes within plants, by applying the liquid carrier concentrate as defined in claim 1 or an agricultural active comprising the liquid carrier concentrate of claim 15 to at least one plant, area adjacent to a plant, root of a plant, foliage of a plant, and/or seed adapted to produce a plant.

19. The method according to claim 17 wherein an effective amount of the agricultural active formulation or of the liquid carrier concentrate is applied to plants (crop or undesired ones), seeds or to the soil.

20. The method according to claim 18 wherein an effective amount of the agricultural active formulation or of the liquid carrier concentrate is applied to plants (crop or undesired ones) or to seeds.
